(19) United States
(12) Patent Application Publication
(10) Pub. No.: US 2023/0367798 A1
(43) Pub. Date: Nov. 16, 2023

(54) METHOD AND SYSTEM FOR PROVIDING SEAMLESS ACCESS TO INDUSTRIAL DATA IN A DATA LAKE IN A CLOUD COMPUTING ENVIRONMENT

(71) Applicant: SIEMENS AKTIENGESELLSCHAFT, München (DE)

(72) Inventors: Atul Jawale, Pune, Maharashtra (IN); Ashish Kolhe, Pune, Maharashtra (IN); Prithviraj Patil, Pune, Maharashtra (IN); Tej Pratap Singh Yadav, Pune, Maharashtra (IN)

(21) Appl. No.: 18/028,707

(22) PCT Filed: Sep. 27, 2021
(86) PCT No.: PCT/EP2021/076487

§ 371 Date: Mar. 27, 2023

(30) Foreign Application Priority Data
Sep. 28, 2020 (IN) 202031042032

(51) Int. Cl. G06F 16/33; G06F 16/338

(52) U.S. Cl. CPC G06F 16/3344; G06F 16/338

(57) ABSTRACT

A method and a system for providing seamless access to industrial data in a data lake in a cloud computing environment are provided. The method includes receiving a request to provide access to industrial data in a data lake from a user device. The request includes a semantic query for the industrial data. The semantic query is based on a semantic model. The method includes dynamically generating a representation of the industrial data based on data sets of the industrial data in the industrial data lake using the semantic model associated with the semantic query. The method includes generating results of the semantic query based on the representation of the industrial data. The results include the requested industrial data from the data lake. The method also includes providing the generated results of the semantic query to the user device.

This application is the National Stage of International Application No. PCT/EP2021/076487, filed Sep. 27, 2021, which claims the benefit of Indian Patent Application No. IN 202031042032, filed Sep. 28, 2020. The entire contents of these documents are hereby incorporated herein by reference.

### BACKGROUND

The present embodiments generally relate to the field of cloud computing system, and more particularly to a method and system for providing seamless access to industrial data in a data lake in a cloud computing environment.

Generally, a cloud computing system provides storage, analytics, and visualization of industrial data associated with devices in an industrial plant. The industrial data is collected periodically from different data sources (e.g., field devices, ERP systems, PLM systems, Design tools, etc.) and stored in a data lake. The industrial data is not structured or organized in a meaningful way, and hence, sometimes it may be difficult to provide seamless access to the industrial data to users who wish to access the industrial data from the data lake. This is due to the fact that the industrial data in the data lake includes disjoint data sets.

Currently, the cloud computing system uses abstraction layer to users to create a semantic model for accessing the industrial data based on domain (e.g., design, inventory planning, production planning, etc.). The semantic model represents relationships between business properties (e.g., attributes that represent real-time objects, processes, parameters, etc.). The business properties are then mapped to underlying data sets of the industrial data in the data lake using a property relations edge between business properties and a mappings edge with underlying data sets that represents a business property. When a business property is mapped to underlying data sets across enterprise systems and applications, there exists one-to-one or one-to-many or many-to-one relationship types. These relationship types decide how business properties are associated with the underlying data sets. However, the mappings are done based on commonality between two or more disjoint data sets from different data sources. Hence, results of the semantic queries may be based on single use case, thereby causing inconvenience to the user to access the industrial data for different use-cases.

### SUMMARY AND DESCRIPTION

The scope of the present invention is defined solely by the appended claims and is not affected to any degree by the statements within this summary.

There exists a need to provide seamless access to industrial data in a data lake in a cloud computing environment.

The present embodiments may obviate one or more of the drawbacks or limitations in the related art. For example, seamless access to industrial data in a data lake in a cloud computing environment is provided.

As another example, seamless access to industrial data in a data lake in a cloud computing environment is provided. The method includes receiving a request to access to industrial data in a data lake from a user device. The request includes a semantic query for the industrial data. The semantic query is based on a semantic model. The data lake includes data sets of the industrial data from a plurality of data sources. The method includes dynamically generating a representation of the industrial data based on the data sets of the industrial data in the data lake using the semantic model associated with the semantic query. Further, the method includes generating results of the semantic query based on the representation of the industrial data. The results include the requested industrial data from the data lake. Additionally, the method includes providing the generated results of the semantic query to the user device.

In an embodiment, the method may include generating the representation of the industrial data based on a configuration setting value and the semantic model. The configuration setting value indicates mapping between the different data sets in the data lake. In generating the representation of the industrial data based on the configuration setting value and the semantic model, the method may include determining mapping between the data sets of the industrial data from the plurality of data sources using the configuration setting value, and retrieving the mapped data sets from the data lake. The method may include mapping the data sets retrieved from the data lake to one or more class properties associated with at least one class of the semantic model. Further, the method may include generating the representation of the industrial data based on the data sets retrieved from the data lake mapped to the one or more class properties of the at least one class of the semantic model.

In another embodiment, the method may include storing the representation of the industrial data along with the configuration setting value in a database.

In yet another embodiment, in dynamically generating the representation of the industrial data, the method may include determining whether there exists a representation of the industrial data in the database based on a configuration setting value. If the representation of the industrial data is not found in the database, the method may include generating the representation of the industrial data based on the configuration setting value. If the representation of the industrial data is found in the database, the method may include obtaining the representation of the industrial data from the database.

In still another embodiment, the method may include generating a semantic model for accessing the industrial data from the data lake using the semantic query.

As yet another example, a cloud computing system for providing seamless access to industrial data in a data lake in a cloud computing environment is provided. The cloud computing system includes at least one processing unit and a memory communicatively coupled to the processing unit. The memory includes a data access module configured to perform a method as described above.

As another example, a non-transitory computer-readable storage medium, having machine-readable instructions stored therein, that, when executed by a processing unit, cause the processing unit to perform a method as described above is provided.

The above-mentioned and other features of the present embodiments will now be addressed with reference to the accompanying drawings. The illustrated embodiments are intended to illustrate, but not limit the invention.

### BRIEF DESCRIPTION OF THE DRAWINGS

FIG. 1 is a block diagram of a cloud computing environment for providing seamless access to industrial data in a data lake, according to an embodiment;

FIG. 2 is a block diagram of a data access module such as shown in FIG. 1, according to an embodiment;

FIG. 3 is a process flowchart depicting an example of a method of providing seamless access to the industrial data in the data lake, according to an embodiment; and

FIG. 4 is a block diagram of a cloud computing system such as shown in FIG. 1, according to an embodiment.

### DETAILED DESCRIPTION

Various embodiments are described with reference to the drawings, where like reference numerals are used to refer the drawings, and where like reference numerals are used to refer to like elements throughout. In the following description, for the purpose of explanation, numerous specific details are set forth in order to provide thorough understanding of one or more embodiments. It may be evident that such embodiments may be practiced without these specific details.

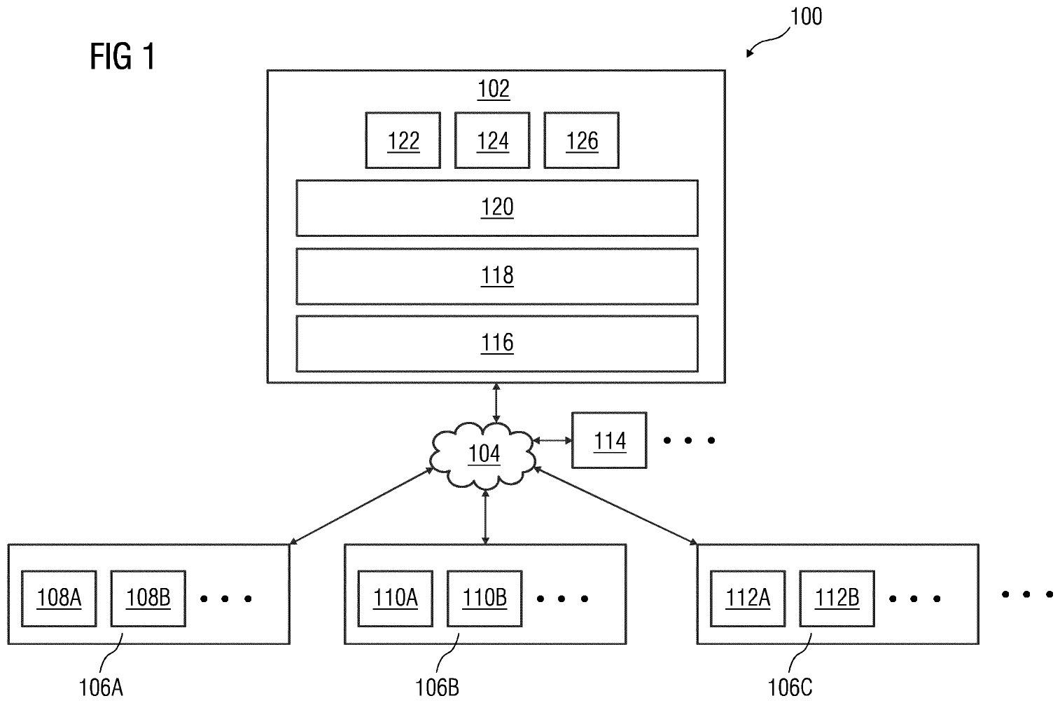

FIG. 1 is a schematic representation of a cloud computing environment 100 for providing seamless access to industrial data stored in a data lake 124, according to an embodiment. For example, FIG. 1 depicts a cloud computing system 102 that is capable of providing cloud services for providing seamless access to industrial data. The cloud computing system 102 is connected to assets 108A-N, assets 110A-N, and assets 112A-N in the technical installation (e.g., industrial plant) 106A-N via a network 104 (e.g., Internet). The assets 108A-N, 110A-N, and 112A-N may include servers, robots, switches, automation devices, motors, valves, pumps, actuators, sensors, field devices, and other industrial equipment. According to the present embodiments, the cloud services may include providing seamless access to the industrial data stored in the data lake 124 using a sematic query. The cloud service may enable to design, engineer, manufacture, commission, control, and maintain the assets 108A-N, 110A-N, and 112A-N or industrial plants 106A-N. The cloud computing system 102 is also connected to user devices 114 via the network 104. The user devices 114 may include laptop computer, workstation, desktop computer, tablet computer, smart phone, and the like. The user devices 114 may access the cloud computing system 102 for accessing the industrial data stored in the data lake 124. The cloud computing system 102 may be hosted on a public cloud, private cloud, hybrid cloud, and the like.

The cloud computing system 102 includes a cloud communication interface 116, cloud computing hardware and OS 118, a cloud computing platform 120, a data access module 122, a data lake 124, and a database 126. The cloud communication interface 116 enables communication between the cloud computing platform 120 and the industrial plants 106A-N. Also, the cloud communication interface 116 enables communication between the cloud computing platform 120 and the user devices 114.

The cloud computing hardware and OS 118 may include one or more servers on which an operating system is installed and including one or more processing units, one or more storage devices for storing data, and other peripherals required for providing cloud computing functionality. The cloud computing platform 120 is a platform that implements functionalities such as data storage, data analysis, data visualization, data communication on the cloud computing hardware and OS 118 via APIs and algorithms. The cloud computing platform 120 also delivers the aforementioned cloud services by executing the data access module 122. In other words, the cloud computing platform 120 employs the data access module 122 for providing seamless access to industrial data in the data lake 124. The cloud computing platform 120 may include a combination of dedicated hardware and software built on top of the cloud hardware and OS 118.

The data access module 122 is configured to generate a representation of industrial data using datasets in the data lake 124 based on a configuration setting value and a sematic model. The configuration setting value is provided by the user devices 114 along with the semantic model. The configuration setting value indicates mapping between different data sets of the industrial data in the data lake. The configuration setting value may vary from one instance to another, thereby enabling different combinations of industrial data to be mined from the data lake 124. The data access module 122 is configured to generate results of a semantic query received from the user devices 114 based on the representation of the industrial data. The results may include the industrial data requested by the user devices 114 via the semantic query. The data access module 122 is configured to provide the results of the semantic query to the user devices 114. In one embodiment, the results of the semantic query are visualized on the respective user devices 114. In another embodiment, the results of the semantic query are analyzed using analytics algorithm and then visualized using a visualization application on the respective user devices 114.

Additionally, the data access module 122 is configured to generate one or more semantic models for accessing the industrial data in the data lake 124. Also, the data access module 122 is configured to generate one or more semantic queries for accessing the industrial data in the data lake 124.

The data lake 124 is capable of storing data sets of industrial data from a plurality of data sources (e.g., ERP database, PLM database, etc.). The database 126 is capable of storing representations of the industrial data along with the configuration setting value. This enables the data access module 122 to reuse the representations of the industrial data for generating results of semantic query when the configuration setting value associated with the semantic model is unchanged. The database 126 is capable of storing the semantic models received from the user devices 114.

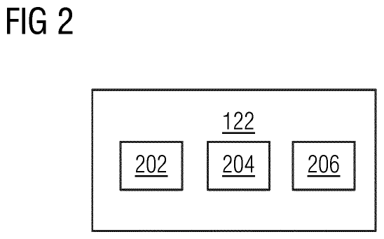

FIG. 2 is a block diagram of the data access module 122 such as those shown in FIG. 1, according to an embodiment. The data access module 122 includes a semantic service module 202, a query service module 204, and a query engine 206.

The semantic service module 202 is configured to receive configuration setting value and a semantic model for accessing industrial data from the data lake 124. Also, the semantic service module 202 is configured to generate the semantic model for accessing the industrial data. The semantic service module 202 is configured to generate representation of the industrial data based on the configuration setting value and the semantic model using the data sets in the data lake 124. The semantic service module 202 is configured to store the representation of the industrial data in the database 126.

The query service module 204 is configured for generating a semantic query for accessing the desired industrial data from the data lake 124 based on the semantic model and the configuration setting value. The query engine 206 is configured to process the semantic query for accessing the industrial data and generate results to the semantic query using the data sets in the data lake 124 based on the representation of the industrial data. Further, the query engine 206 is configured to provide the results of the semantic query to the user devices 114 via the query service module 204.

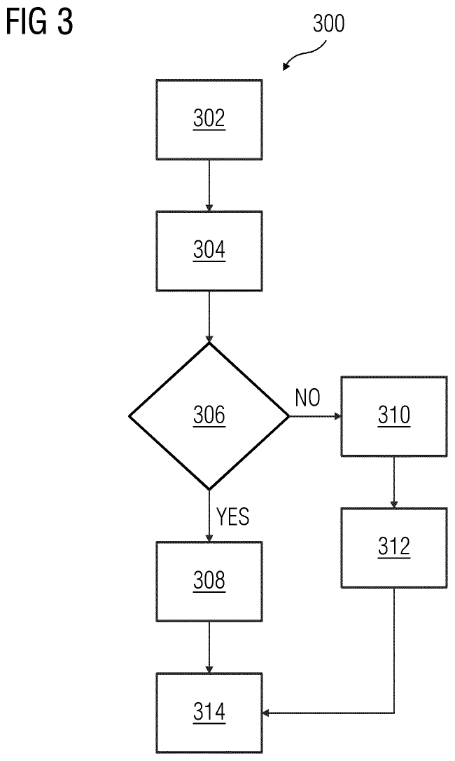

FIG. 3 is a process flowchart 300 depicting an exemplary method of providing seamless access to industrial data in a data lake, according to an embodiment. At act 302, a request to provide access to industrial data in a data lake is received from a user device. The request includes a semantic query for the industrial data. The semantic query is based on a semantic model. The data lake includes data sets of the industrial data from a plurality of data sources (e.g., Enterprise Resource Planning (ERP) database, Product Lifecycle Management (PLM) database, etc.).

At act 304, a configuration setting value and a semantic model are received from the user device. The configuration setting value indicates mapping between the different data sets of the industrial data in the data lake. In one embodiment, the configuration setting value is at a class level. In another embodiment, the configuration setting value is at a semantic model level. At act 306, it is determined whether there exists a representation of the industrial data in a database based on the configuration setting value. If the representation of the industrial data is found in the database, at act 308, the representation of the industrial data is obtained from the database and the process is routed to act 314.

If the representation of the industrial data is not found in the database, at act 310, the representation of the industrial data is dynamically generated based on the data sets of the industrial data in the data lake using the configuration setting value and the corresponding semantic model. In an exemplary implementation, mapping between the data sets of the industrial data from the plurality of data sources is determined using the configuration setting value. Then, the mapped data sets are retrieved from the data lake. Accordingly, the data sets retrieved from the data lake are mapped to one or more class properties associated with at least one class of the semantic model. Consequently, the representation of the industrial data is generated based on the data sets retrieved from the data lake mapped to the one or more class properties of the at least one class of the semantic model. At act 312, the representation of the industrial data is stored along with the configuration setting value in the database.

At act 314, results of the semantic query are generated based on the representation of the industrial data. The results include the requested industrial data from the data lake. At act 316, the generated results of the semantic query are provided to the user device. Accordingly, the generated results of the semantic query are displayed on a graphical user interface of the user device. In this manner, access to industrial data stored in a data lake is seamlessly provided to a user of the cloud computing system 102.

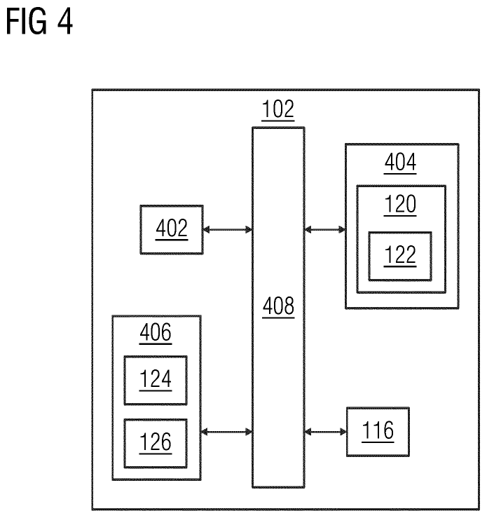

FIG. 4 is a schematic representation of the cloud computing system 102 such as those shown in FIG. 1, according to an embodiment. The cloud computing system 102 includes processing units 402, a memory unit 404, a storage unit 406, a communication interface 408, and the cloud communication interface 116.

The processing units 402 may be one or more processor (e.g., servers). The processing units 402 are capable of executing machine-readable instructions stored on a computer-readable storage medium (e.g., a non-transitory computer-readable storage medium) such as the memory unit 404 for performing one or more functionalities described in the foregoing description including but not limited to providing seamless access to industrial data in the data lake 124. The memory unit 404 includes the data access module 122 stored in the form of machine-readable instructions and executable by the processing units 402.

The storage unit 406 may be volatile or non-volatile storage. In the embodiment, the storage unit 406 includes the data lake 124 for storing data sets of industrial data from a plurality of external data sources. The storage unit 406 also includes the database 126 for storing representations of industrial data along with corresponding configuration setting value and semantic models. The communication interface 408 acts as interconnect means between different components of the cloud computing system 102. The communication interface 408 may enable communication between the processing units 402, the memory unit 404, and the storage unit 406. The processing units 402, the memory unit 404, and the storage unit 406 may be located in a same location or at different locations remote from the industrial plants 106A-N.

The cloud communication interface 116 is configured to establish and maintain communication links with the industrial plants 106A-N. Also, the cloud communication interface 116 is configured to maintain a communication channel between the cloud computing system 102 and the user devices 114.

Those of ordinary skilled in the art will appreciate that the hardware depicted in FIG. 4 may vary for specific implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter may also may be used in addition or in place of the hardware depicted. The depicted example is provided for the purpose of explanation only and is not meant to imply architectural limitations with respect to the present disclosure.

The present embodiments may take a form of a computer program product including program modules accessible from computer-usable or computer-readable medium storing program code for use by or in connection with one or more computers, processors, or instruction execution system. For the purpose of this description, a computer-usable or computer-readable medium may be any apparatus that may contain, store, communicate, propagate, or transport the program for use by or in connection with the instruction execution system, apparatus, or device. The medium may be electronic, magnetic, optical, electromagnetic, infrared, or a semiconductor system (or apparatus or device), or propagation mediums in and of themselves as signal carriers are not included in the definition of physical computer-readable medium, which includes a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and DVD. Both processors and program code for implementing each aspect of the technology may be centralized or distributed (or a combination thereof) as known to those skilled in the art.

While the present invention has been described in detail with reference to certain embodiments, it should be appreciated that the present invention is not limited to those embodiments. In view of the present disclosure, many modifications and variations would be present themselves, to those skilled in the art without departing from the scope of the various embodiments of the present invention, as described herein. The scope of the present invention is, therefore, indicated by the following claims rather than by the foregoing description. All changes, modifications, and variations coming within the meaning and range of equivalency of the claims are to be considered within their scope. All advantageous embodiments claimed in method claims may also apply to system/apparatus claims.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method of providing seamless access to unstructured industrial data in a data lake in a cloud computing environment, wherein the data lake comprises disjoint data sets of the industrial data from a plurality of data sources, the method comprising:
receiving, by a processing unit, a request to access to the industrial data in the data lake from a user device, wherein the request comprises a semantic query for the industrial data, and wherein the semantic query is based on a semantic model;
dynamically generating a representation of the industrial data using data sets of the industrial data in the industrial data lake using the semantic model associated with the semantic query and a configuration setting value provided by the user device;
generating results of the semantic query based on the representation of the industrial data, wherein the results comprise the requested industrial data from the data lake; and
providing the generated results of the semantic query to the user device,
wherein the configuration setting value indicates mapping between different data sets in the data lake.

2. (canceled)

3. The method of claim 1, wherein the configuration setting value is at a class level.

4. (canceled)

5. The method of claim 3, wherein generating the representation of the industrial data based on the configuration setting value and the semantic model comprises:
determining mapping between the data sets of the industrial data from the plurality of data sources using the configuration setting value;
retrieving the mapped data sets from the data lake;
mapping the data sets retrieved from the data lake to one or more class properties associated with at least one class of the semantic model; and
generating the representation of the industrial data based on the data sets retrieved from the data lake mapped to the one or more class properties of the at least one class of the semantic model.

6. The method of claim 5, further comprising:
storing the representation of the industrial data along with the configuration setting value in a database.

7. The method of claim 6, wherein dynamically generating the representation of the industrial data comprises:
determining whether there exists a representation of the industrial data in the database based on a configuration setting value;
when the representation of the industrial data is not found in the database, generating the representation of the industrial data based on the configuration setting value; and
when the representation of the industrial data is found in the database, obtaining the representation of the industrial data from the database.

8. The method of claim 1, further comprising:
generating a semantic model for accessing the industrial data from the data lake using the semantic query.

9. A cloud computing system comprising:
at least one processing unit; and
a memory communicatively coupled to the processing unit,
wherein the memory comprises a data access module configured to provide seamless access to unstructured industrial data in a data lake in a cloud computing environment, wherein the data lake comprises disjoint data sets of the industrial data from a plurality of data sources, the provision of the seamless access comprising:
receipt, by a processing unit, of a request to access to the industrial data in the data lake from a user device, wherein the request comprises a semantic query for the industrial data, and wherein the semantic query is based on a semantic model;
dynamic generation of a representation of the industrial data using data sets of the industrial data in the industrial data lake using the semantic model associated with the semantic query and a configuration setting value provided by the user device;
generation of results of the semantic query based on the representation of the industrial data, wherein the results comprise the requested industrial data from the data lake; and
provision of the generated results of the semantic query to the user device,
wherein the configuration setting value indicates mapping between different data sets in the data lake.

10. A non-transitory computer-readable storage mediums that stores machine-readable instructions executable by a processing unit to provide seamless access to unstructured industrial data in a data lake in a cloud computing environment, wherein the data lake comprises disjoint data sets of the industrial data from a plurality of data sources, the machine-readable instructions comprising:
receiving, by a processing unit, a request to access to the industrial data in the data lake from a user device, wherein the request comprises a semantic query for the industrial data, and wherein the semantic query is based on a semantic model;
dynamically generating a representation of the industrial data using data sets of the industrial data in the industrial data lake using the semantic model associated with the semantic query and a configuration setting value provided by the user device;
generating results of the semantic query based on the representation of the industrial data, wherein the results comprise the requested industrial data from the data lake; and
providing the generated results of the semantic query to the user device,
wherein the configuration setting value indicates mapping between different data sets in the data lake.

11. The non-transitory computer-readable storage medium of claim 10, wherein the configuration setting value is at a class level.

12. The non-transitory computer-readable storage medium of claim 11, wherein generating the representation of the industrial data based on the configuration setting value and the semantic model comprises:
determining mapping between the data sets of the industrial data from the plurality of data sources using the configuration setting value;
retrieving the mapped data sets from the data lake;
mapping the data sets retrieved from the data lake to one or more class properties associated with at least one class of the semantic model; and
generating the representation of the industrial data based on the data sets retrieved from the data lake mapped to the one or more class properties of the at least one class of the semantic model.

13. The non-transitory computer-readable storage medium of claim 12, wherein the machine-readable instructions further comprise:
storing the representation of the industrial data along with the configuration setting value in a database.

14. The non-transitory computer-readable storage medium of claim 13, wherein dynamically generating the representation of the industrial data comprises:
determining whether there exists a representation of the industrial data in the database based on a configuration setting value;
when the representation of the industrial data is not found in the database, generating the representation of the industrial data based on the configuration setting value; and
when the representation of the industrial data is found in the database, obtaining the representation of the industrial data from the database.

15. The non-transitory computer-readable storage medium of claim 10, wherein the machine-readable instructions further comprise:
generating a semantic model for accessing the industrial data from the data lake using the semantic query.

16. The method of claim 1, wherein the configuration setting value is at a semantic model level.
